(19) United States
(12) Patent Application Publication
(10) Pub. No.: US 2018/0343277 A1
(43) Pub. Date: Nov. 29, 2018

(54) ELASTIC POLICY TUNING BASED UPON CROWD AND CYBER THREAT INTELLIGENCE

(71) Applicant: CHECK POINT SOFTWARE TECHNOLOGIES LTD., TEL AVIV (IL)

(72) Inventors: Lior DRIHEM, Givat Shmuel (IL); Meir Jonathan Dahan, Tel Aviv (IL); Matan Mishan, Rishon LeZion (IL); Maya Horowitz, Tel Aviv (IL)

(21) Appl. No.: 15/604,711

(22) Filed: May 25, 2017

(51) Int. Cl. H04L 29/06

(52) U.S. Cl. CPC H04L 63/1433; H04L 63/20; H04L 63/145; H04L 63/1441

(57) ABSTRACT

Actively and passively monitoring current network security threats and impact, to evaluate and maintain cyber security includes using an innovative combination of threat feed, impact assessment, client profile, security policy, and vulnerability report to determine impact of malware, evaluate and maintain security policy, decrease vulnerability, and dynamically implement solutions to prevent malware attacks. Constantly re-evaluating the customer's cyber security implementation facilitates dynamic tuning of cyber security implementation.

### FIELD OF THE INVENTION

The present invention generally relates to cyber security, and in particular, it concerns improved dynamic tuning of security.

### BACKGROUND OF THE INVENTION

Refer to the drawings FIG. 1A, a sketch of conventional cyber security implementation. Conventional techniques are based on a security policy that is enforced and produces logs that can be audited. The results of the audit can be used to update the security policy.

As cyber threats continue and increase, it is desirable to have improved systems and methods for cyber security.

### SUMMARY

According to the teachings of the present embodiment there is provided a method for cyber security of an internal network, comprising the steps of: receiving a threat feed of cyber security incidents; receiving an impact assessment for each of said cyber security incidents; performing an evaluation of said threat feed based on said impact assessment, a security policy, a profile, and a vulnerability report; generating a suggested implementation, based on said evaluation.

According to the teachings of the present embodiment there is provided a system for cyber security of an internal network, the system comprising: a network security device configured to: receive a threat feed of cyber security incidents; receive an impact assessment for each of said cyber security incidents; perform an evaluation of said threat feed based on said impact assessment, a security policy, a profile, and a vulnerability report; generate a suggested implementation, based on said evaluation.

In an optional embodiment, the cyber security incidents are malware incidents including a source and destination of the security incident and an identifier of malware involved in the security incident.

In another optional embodiment, the identifier is associated with a corresponding severity of impact and confidence of identification of said malware. In another optional embodiment, the threat feed is from a global database of malware incidents. In another optional embodiment, the threat feed is based on said profile. In another optional embodiment, the impact assessment is included in said threat feed.

In another optional embodiment, the profile includes information regarding the internal network, selected from the group comprising: area of business served by the internal network; size of the company operating the internal network; and country in which the internal network is deployed.

In another optional embodiment, the vulnerability report is generated by running a check of the security of the internal network. In another optional embodiment, the suggested implementation is based on publications from a publication database.

In another optional embodiment, the suggested implementation is approved and implemented for the internal network. In another optional embodiment, after said suggested implementation is implemented, the internal network is tested against malware in said security incidents other than malware in said vulnerability report.

According to the teachings of the present embodiment there is provided a non-transitory computer-readable storage medium having embedded thereon computer-readable code for cyber security the computer-readable code comprising program code for: receiving a threat feed of cyber security incidents; receiving an impact assessment for each of said cyber security incidents; performing an evaluation of said threat feed based on said impact assessment, a security policy, a profile, and a vulnerability report; generating a suggested implementation, based on said evaluation.

According to the teachings of the present embodiment there is provided a computer program that can be loaded onto a server connected through a network to a client computer, so that the server running the computer program constitutes a network security device in a system according to any one of the above claims.

### BRIEF DESCRIPTION OF FIGURES

The embodiment is herein described, by way of example only, with reference to the accompanying drawings, wherein:

FIG. 1A, a sketch of conventional cyber security implementation.

FIG. 1B, a sketch of an improved method for dynamic tuning of cyber security implementation.

FIG. 2, a diagram of a system for improved cyber security.

FIG. 3, a flowchart of a method of implementing cyber threat intelligence (CTI)

FIG. 4, a high-level partial block diagram of an exemplary system configured to implement the network security device.

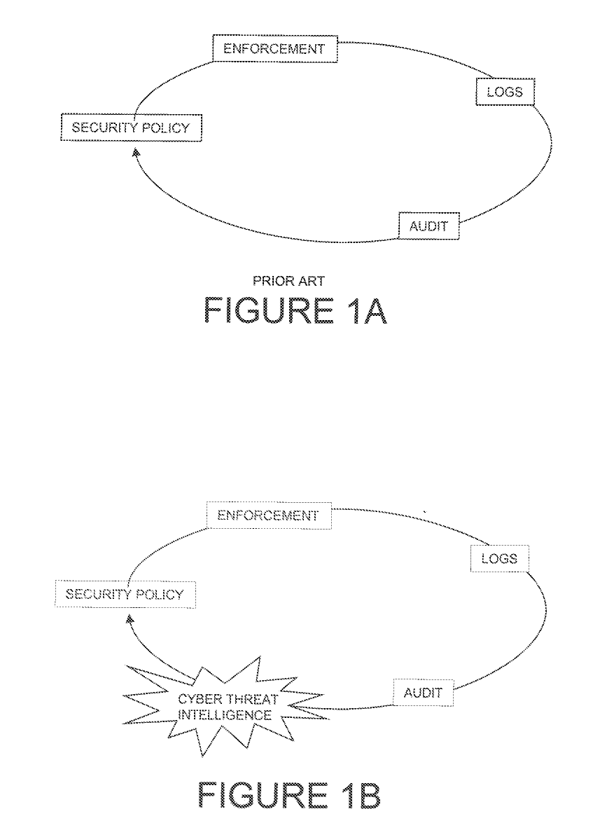

### DETAILED DESCRIPTION—FIRST EMBODIMENT—FIGS. 1 TO 4

The principles and operation of the system and method according to a present embodiment may be better understood with reference to the drawings and the accompanying description. A present invention is a system for actively and passively monitoring current network security threats and impact, to evaluate and maintain security policy, vulnerability assessment, and solutions.

Conventional techniques are based on a security policy that is enforced and produces logs that can be audited. Network security products based on this current concept of policy, enforcement, and audit are limited in assessing, reacting, informing, and changing based on current, changing threats to the installed security mechanisms.

Refer to the drawings FIG. 1B, a sketch of an improved method for dynamic tuning of cyber security implementation. A feature of the current embodiment is incorporation of cyber threat intelligence (CTI). Cyber threat intelligence integrates a novel layer that can fundamentally alter the accepted structure for implementing security policy. In particular, the cyber threat intelligence can monitor, test, evaluate, assess, and then be used to dynamically tune security mechanisms to a dynamic security landscape. Security mechanisms include a security policy, as well as hardware, software, and configurations.

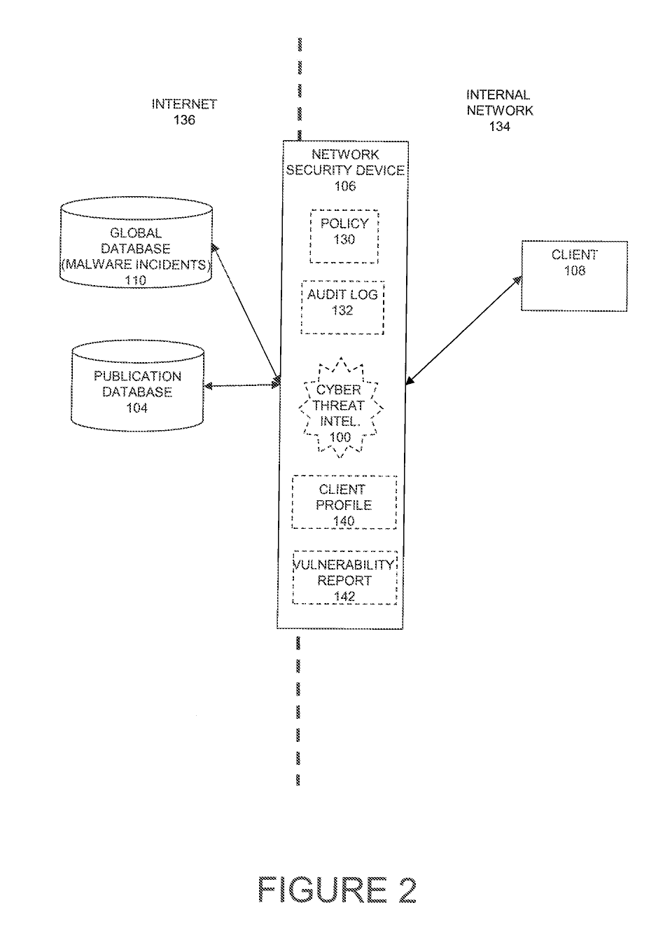

Referring now to the drawings, FIG. 2, a diagram of a system for improved cyber security. A network security device 106 enforces at least one policy 130 and generates at least one audit log 132. The network security device 106 typically is deployed between an internal network 134 and the Internet 136. The network security device 106 protects at least one client 108 on the internal network 134. A publication database (publication db/DB, 104) includes malware publications. A global database (global DB 110) includes malware incidents. A cyber threat intelligence module 100 is shown deployed on the network security device 106.

For clarity in this document, the term “network security” is used. However, one skilled in the art will realize that this term includes computer security in general, and can be implemented to protect networks, one or more computers, and similar devices, in particular protecting devices from malware.

In the context of this document, the term “malware” (malicious software) is generally used to refer to any method to infiltrate a computer. Malware includes software that is intended to damage, disrupt, or disable computers and computer systems, gather sensitive information, gain access to private computer systems, or display unwanted advertising. Malware also includes techniques such as side scripting (XSS), SQL injection (SQLi), and command injection (CMDi). Malware can be designed to gain access or damage a computer without the knowledge of the owner. There are various types of malware including spyware, key loggers, viruses, worms, Trojans, bots, spyware, adware, and ransomware.

The network security device 106 is typically a router, gateway, and/or firewall implemented as an independent hardware device or as a module on another hardware device. In general, the network security device 106 is a processing device including one or more processors configured to implement the cyber threat intelligence module 100. Modules such as the policy 130, the audit log 132, the client profile 140, and the vulnerability report 142 can be deployed on the network security device 106, or on another device preferably on the customer's internal network 134, accessible to the network security device 106.

For clarity in this document, reference is to one security policy, the policy 130. It is known in the art that security policies can be implemented as one or more policies. Based on this description one skilled in the art will be able to implement embodiments based on one or more policies. In general, a policy (security policy) is a collection of rules. A rule mainly includes a malware identifier (also referred to as simply an “identifier”) and an action. An identifier, without loss of generality, is defined as pattern. Patterns include explicit characteristics or implicit behaviors of the malware. Identifiers typically include characteristics of severity of the malware (performance impact of the malware) and confidence that the pattern is an indication of the specific malware. Identifiers can also include IOCs (indicators of compromise), such as domains, uniform resource locators (URLs), and specific files (such as an MD5 signature of the file). Actions include instructions on what to do with data that is identified as malware, for example to drop the data or only to detect the data (and then log and/or notify that malware data has been detected).

For clarity in this document, reference is to one audit log 132. However, it is known in the art that audit logs can be implemented as one or more data structures. Based on this description one skilled in the art will be able to implement embodiments based on one or more audit logs. In general, an audit log is a security-relevant chronological record, which provides documentary evidence of the sequence of activities that have affected at any time a specific operation, procedure, or event. An audit log can be used to track (automatically or manually) every action undertaken by users, devices, and processes on a network. For example, an audit log can record what time a user logged on, which files the user opened, what the user changed in a file, what software and processes are running, what each process is, and the accesses a process requests. When the network security device 106 detects malware, one or more entries are made in the audit log 132. The audit log entry can include information on the malware such as the name of the malware, the confidence that the identification of the malware is correct, where the malware is running, under which user account, what resources are being requested, and what files the malware is attempting to access.

The internal network 134 can be a variety of private networks, such as a company network or home network, generally the customer network to be protected by the CTI 100. The Internet 136 is generally a network other than the internal network 134, typically with little or no control by the owners of the internal network 134 as to what devices and software are deployed on the Internet 136.

For clarity in this document, reference is to one client 108. In the current figure, the client 108 is shown in a typical configuration on the internal network 134, behind and protected by the network security device 106 from the Internet 136. The Internet 136 is the entity on the other side of the network security device 106 from the client 108. In general, the network security device 106 protects the internal network 134. Typically, the internal network includes at least one client 108, normally a plurality of clients, and often a multitude of clients.

The publication database (publication DB) 104 is a collection of data, typically implemented as a database, of malware publications. As shown in the current figure, the publication DB 104 is typically implemented on the Internet 136, for example, preferably accessed as a (third-party) service on the Internet 136. The publication DB 104 can be deployed to alternate locations, for example, on the internal network 134.

Each malware publication (or simply referred to in the context of this document as a “publication”) includes intelligence that analysts and researchers gathered regarding a specific malware, threat campaign, vulnerability, or attack. A publication can include technical data, and/or an analysis of where and when a certain malware is spread. A publication typically also includes solutions—recommendations on how to block similar attacks (on a client, network, etc.) Solutions can include one or more suggestions for one or more policy rules defined according to matched malware identifiers.

Each malware publication is tagged. The tagging of each publication typically includes tags for malware names, malware families, and for solutions, which will later be correlated with a customer's environment. All of this information regarding the malware is tagged onto a malware publication, supporting the CTI (cyber threat intelligence) 100, and facilitating the CTI smarter decision making for a better policy, as compared to conventional cyber security techniques.

Publications and tagging are typically produced and done by professional, industry researchers. New security incidents are captured, analyzed, associated with a particular new or existing malware, and one or more solutions to the malware developed. If the security incident indicates a new malware, a new publication can be produced (written) and released (pushed, updated to the publication DB 104). If the security incident indicates an existing malware as the source of the incident, the existing publication for the existing malware can be updated with new and/or additional information learned from the incident regarding the malware and/or new and updated solutions to protect and handle the existing malware.

Tagging can be either a manual or automatic process, and includes associating the publication for a particular malware with one or more malware identifiers. Tagging can also include information such as: IOCs, vulnerabilities exploited, malware name, malware family, popular source country, popular destination country, and campaign name of the attack. As noted, each publication has an associated malware identifier (or simply “identifier”). As described above, each identifier typically includes characteristics of severity of the malware (impact of the malware) and confidence that the pattern is an indication of the specific malware. Each publication preferably includes one or more solutions to mitigate attacks from the malware. There is a many-to-many connection between identifiers and publications. In addition to a publication having an associated name (malware name), solutions can have one or more associated malware identifiers (names).

A global database of malware incidents, referred to in this document as “global DB” 110, is a collection of data, typically implemented in a database, of security incidents and associated malware information. A malware incident includes the source and destination of the incident and an identification (for example, name or identifier) of the malware involved in the incident. In other words, a malware incident can be defined as a tuple of source, destination, and malware identifier. The global DB 110 is global in the sense that all known malware incidents, or as many malware incidents as possible/as known and accessible, are included in the database. The global DB 110 is typically maintained and accessed via the Internet 136, as shown in the current figure. The global DB 110 can be deployed to alternate locations, for example, as a private database on the internal network 134.

A cyber threat intelligence (CTI) module 100 can be deployed as one or more software, hardware, and firmware modules, or combinations thereof. In the current figure, the CTI 100 is shown configured on the network security device 106. This configuration is not limiting. Alternatively, the CTI 100 can be deployed, for example, on the client 108 (for example as a browser plug-in) or another device on the internal network 134. The CTI 100 can be viewed by definition of cyber security as requiring implementation on a computer, thereby improving the functioning of the computer itself.

A client profile 140 is provided and can be stored on the network security device 106, or at another location accessible by the CTI 100. The client profile 140 includes information on the customer, the entire entity being protected by the CTI 100, and should not be confused and limited to only information regarding the client 108. The client profile 140 normally includes information on at least a portion of the entire internal network 134, typically including information on the entire internal network 134. The client profile 140 can include information such as sector of industry of the company, country in which the company or an internal network 134 is located, business served by the internal network 134, a size of the company operating the internal network 134, and a country in which the internal network 134 is deployed.

A vulnerability report 142 is provided and can be stored on the network security device 106, or at another location accessible by the CTI 100. The vulnerability report 142 can include descriptions of how vulnerable is an internal network 134—what specific security openings, flaws, and/or vulnerabilities exist, which malware is able to impact a customer network, and the level of threat and impact of various possible malware attacks. Alternatively, or in addition, the vulnerability report 142 can include a vulnerability “score”, giving a numerical value to how vulnerable is the customer's current cyber security implementation. The vulnerability report 142 is typically of the current network configuration (configuration of the network security device 106 and internal network 134). The vulnerability report 142 can be generated and provided by a third party, for example a testing service or security assessment service, or can be generated by the customer, for example by running a check of the security of the internal network 134, such as running the Check Point internal 10-step check to check the security of the internal network 134. The vulnerability report 142 can be based at least in part by an audit of logs produced based on (enforcement of) a current security policy 130.

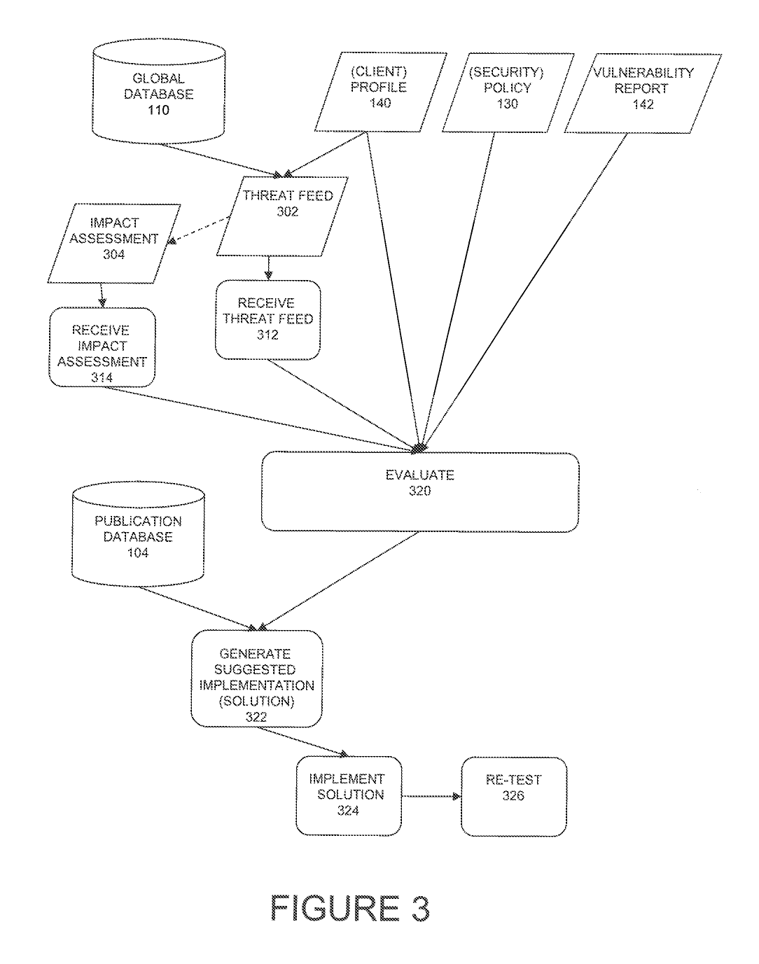

Refer now to FIG. 3, a flowchart of a method of implementing cyber threat intelligence (CTI) 100. A threat feed 302 is received 312, the threat feed including cyber security incidents. The threat feed 302 is typically based on the global DB 110 of malware incidents and the cyber security incidents are malware incidents. The threat feed 302 can be requested (pulled) or preferably pushed continuously to the CTI 100 for constantly re-evaluating the customer's cyber security implementation and dynamic tuning of cyber security implementation. The threat feed 302 is preferably based on the client profile 140, providing specific cyber security threats that are relevant to the customer. For example, the client's geo-location is in the client profile 140, and the threat feed 302 is generated/filtered based on the client's geo-location and common malware indents in the same geo-location. In another example, the client's industry is included in the client profile 140, and the threat feed 302 is generated/filtered to include malware incidents particular to the client's industry.

An impact assessment 304 is received 314. The impact assessment 304 is a security assessment that includes information regarding each of the cyber security incidents in the threat feed 302. Optionally, the impact assessment 304 can be included in the threat feed 302. Alternatively (not shown in the current figure), the threat feed 302 can be used to determine the contents (which cyber security incidents) of a separately received impact assessment 304.

An evaluation 320 is performed of the threat feed 302 based on the impact assessment 304, a (client) profile 140, a (security) policy 130, and a vulnerability report 142. The information from these inputs (the threat feed 302, the impact assessment 304, the client profile 140, the security policy 130, and the vulnerability report 142) are correlated to generate actionable alerts and recommendations.

In a non-limiting example, the customer is a bank in Russia (included in client profile 140). A new malware targeting Lotus Notes is identified. The customer's security policy 130 includes that Lotus Notes is being used by the customer, so we know this new malware is relevant to the customer. The new malware is now included in the threat feed 302. In the current example, the threat feed 302 includes an impact assessment 304 of at least the new malware. The publication DB 104 indicates that this new malware is mainly distributed in Russia and is targeting the financial sector. Since the client profile of the customer includes the financial sector (bank) the importance of this new malware threat is raised in the impact assessment 304. The threat feed 302 includes IOCs used by this new malware. An evaluation 320 (security assessment check) is performed on the customer's internal network 134. If these IOCs used by this new malware are accessible from the customer's network, then the customer (customer's network) is not protected. The evaluation 320 produces a vulnerability report 142 including if the customer is or is not protected, to what degree, and optionally for specifically which IOCs. In the current example, the evaluation 320 included a review of the audit log 132. The resulting vulnerability report 142 includes that Anti Bot (currently installed security product) detected connections from the customer's network to a known command and control (C&C). According to the threat feed 302, this C&C is related to a bot that is dropped by the Lotus Notes malware. This indicates that the customer has already been infected by the new malware. The vulnerability report 142 can also include specific guidance on how to remove current infections, mitigate the threat of the new malware, and protect the customer from future infections.

In an exemplary evaluation, global trends are used to generate a suggested implementation 322. The global DB 110 is scanned to collect all tagged malware identifiers. The publications corresponding to the identifiers are retrieved, for example according to severity of the malware from highest to lowest severity. For each identifier, a solution is added to the suggested implementation. Preferably, the retrieval of publications and suggested solutions are correlated with the security policy 130. In addition, the retrieval of publications and suggested solutions can be correlated with logs and the vulnerability report 142.

Alternatively or in addition to accessing the global DB 110 based on global trends, the global DB 110 can be accessed (“sliced”) according to sectors of industry, country of origination, and other information in the client profile 140 or the

Based on the evaluation, a suggested implementation is generated 322. The suggested implementation is a suggested solution for updating the company's cyber security to handle (mitigate) threats (active, known, and potential) to the customer's company security, including security of the internal network 134 and clients 108.

A suggested implementation is typically one or more suggested solutions, normally a combination of solutions based on the malware publications from the publications DB 104. The synergistic combination of the specified inputs (the threat feed 302, the impact assessment 304, the profile 140, the policy 130, and the vulnerability report 142 for this evaluation 320 facilitates monitoring current network security threats and impact to evaluate and maintain security policy, decrease vulnerability, and dynamically implement solutions.

Suggested implementations can include information such as links to, or actual copies of publications. The publications can be presented to a user of the CTI 100 system to facilitate a better understanding of vulnerability of the user's internal network 134, and for the user to gain specific knowledge of the details of specific malware for which the user's internal network may be vulnerable. The presented publications can be based on a comparing the results of an evaluation (suggested implementation) to an audit log based on the current network configuration, security policy, and current enforcement.

Optionally, a user can request a scan of logs to collect all tagged malware identifiers in the log. Optionally, publications and/or malware identifiers (or malware names) can be retrieved and/or presented based on the data (intelligence) in the publication, such as the severity of the malware or the confidence (for example, from “high” to “low” confidence) in the correct identification of the malware.

Subsequent to generating a suggested implementation, the suggested implementation can be reviewed, revised, approved, and implemented 324, typically as a new security policy 130 on the internal network 134.

After a suggested implementation is implemented, the internal network 134 can be tested/re-tested 326. In particular, the internal network 134 (including all the relevant security components, such as the network security device(s) 106, updated security policy 130, client 108, etc.) can be tested against malware that is in the security incidents (for example, in the threat feed 302 and/or the global DB 110), other than malware in the vulnerability report. In this case, the system may include modules, links, or hooks to generate or initiate generation of test traffic from (or to) the internal network 134, for example to the client machine 108. The test traffic matches the pattern of the malware identifiers.

Testing and re-testing 326 of the internal network can be performed manually, automatically, and/or periodically, in particular to test the effectiveness of the current policy 130.

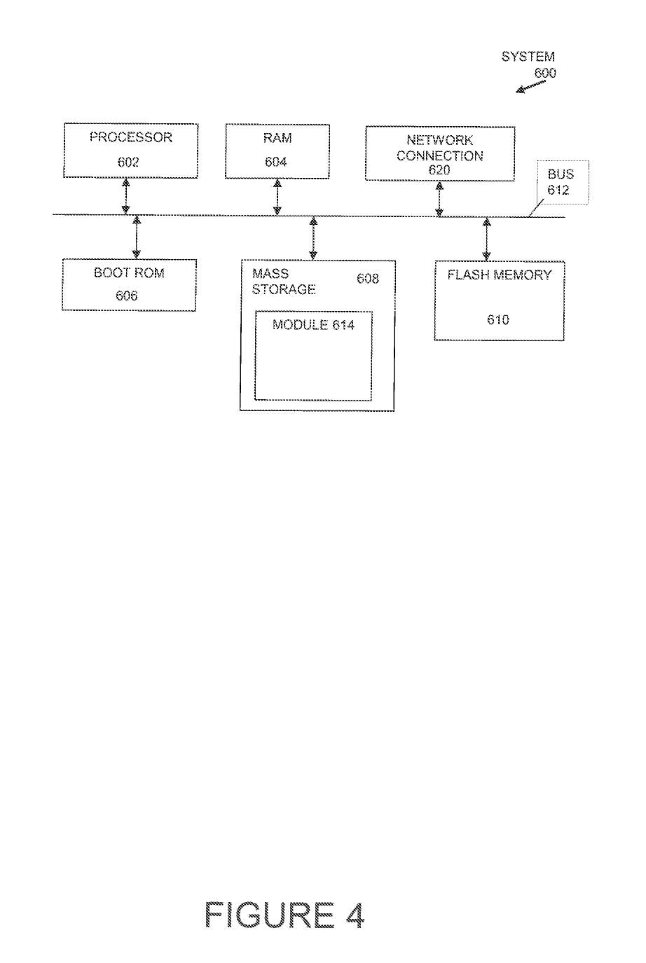

FIG. 4 is a high-level partial block diagram of an exemplary system 600 configured to implement the network security device 106 of the present invention. System (processing system) 600 includes a processor 602 (one or more) and four exemplary memory devices: a RAM 604, a boot ROM 606, a mass storage device (hard disk) 608, and a flash memory 610, all communicating via a common bus 612. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in processor 602 including but not limited to reduced instruction set computer (RISC) architecture and/or complex instruction set computer (CISC) architecture. A module (processing module) 614 is shown on mass storage 608, but as will be obvious to one skilled in the art, could be located on any of the memory devices.

Mass storage device 608 is a non-limiting example of a non-transitory computer-readable storage medium bearing computer-readable code for implementing the cyber security methodology described herein. Other examples of such computer-readable storage media include read-only memories such as CDs bearing such code.

System 600 may have an operating system stored on the memory devices, the ROM may include boot code for the system, and the processor may be configured for executing the boot code to load the operating system to RAM 604, executing the operating system to copy computer-readable code to RAM 604 and execute the code.

Network connection 620 provides communications to and from system 600. Typically, a single network connection provides one or more links, including virtual connections, to other devices on local and/or remote networks. Alternatively, system 600 can include more than one network connection (not shown), each network connection providing one or more links to other devices and/or networks.

System 600 can be implemented as a server or client respectively connected through a network to a client or server.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. Note that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A method for cyber security of an internal network, comprising the steps of:
(a) receiving a threat feed of cyber security incidents;
(b) receiving an impact assessment for each of said cyber security incidents;
(c) performing an evaluation of said threat feed based on said impact assessment, a security policy, a profile, and a vulnerability report;
(d) generating a suggested implementation, based on said evaluation.

2. The method of claim 1 wherein said cyber security incidents are malware incidents including a source and destination of the security incident and an identifier of malware involved in the security incident.

3. The method of claim 2 wherein said identifier is associated with a corresponding severity of impact and confidence of identification of said malware.

4. The method of claim 1 wherein said threat feed is from a global database of malware incidents.

5. The method of claim 1 wherein said threat feed is based on said profile.

6. The method of claim 1 wherein said impact assessment is included in said threat feed.

7. The method of claim 1 wherein said profile includes information regarding the internal network, selected from the group comprising:
(a) area of business served by the internal network;
(b) size of the company operating the internal network; and
(c) country in which the internal network is deployed.

8. The method of claim 1 wherein said vulnerability report is generated by running a check of the security of the internal network.

9. The method of claim 1 wherein said suggested implementation is based on publications from a publication database.

10. The method of claim 1 wherein said suggested implementation is approved and implemented for the internal network.

11. The method of claim 10 wherein after said suggested implementation is implemented, the internal network is tested against malware in said security incidents other than malware in said vulnerability report.

12. A system for cyber security of an internal network, the system comprising: a network security device configured to:
(a) receive a threat feed of cyber security incidents;
(b) receive an impact assessment for each of said cyber security incidents;
(c) perform an evaluation of said threat feed based on said impact assessment, a security policy, a profile, and a vulnerability report;
(d) generate a suggested implementation, based on said evaluation.

13. The system of claim 12 wherein said cyber security incidents are malware incidents including a source and destination of the security incident and an identifier of malware involved in the security incident.

14. The system of claim 13 wherein said identifier is associated with a corresponding severity of impact and confidence of identification of said malware.

15. The system of claim 12 wherein said threat feed is from a global database of malware incidents.

16. The system of claim 12 wherein said threat feed is based on said profile.

17. The system of claim 12 wherein said impact assessment is included in said threat feed.

18. The system of claim 12 wherein said profile includes information regarding the internal network, selected from the group comprising:
(a) area of business served by the internal network;
(b) size of the company operating the internal network; and
(c) country in which the internal network is deployed.

19. The system of claim 12 wherein said suggested implementation is based on publications from a publication database.

20. A non-transitory computer-readable storage medium having embedded thereon computer-readable code for cyber security the computer-readable code comprising program code for:
(a) receiving a threat feed of cyber security incidents;
(b) receiving an impact assessment for each of said cyber security incidents;
(c) performing an evaluation of said threat feed based on said impact assessment, a security policy, a profile, and a vulnerability report;
(d) generating a suggested implementation, based on said evaluation.
